(19) United States
(12) Patent Application Publication
(10) Pub. No.: US 2026/0252286 A1
(43) Pub. Date: Aug. 27, 2026

(54) IMAGE FORMING SYSTEM, NON-TRANSITORY COMPUTER READABLE MEDIUM AND IMAGE FORMING METHOD

(71) Applicant: FUJIFILM Business Innovation Corp., Tokyo (JP)

(72) Inventors: Hisao KOMAZAWA, Kanagawa (JP); Akiho YASUDA, Kanagawa (JP)

(73) Assignee: FUJIFILM Business Innovation Corp., Tokyo (JP)

(21) Appl. No.: 19/308,029

(22) Filed: Aug. 22, 2025

(30) Foreign Application Priority Data
Feb. 21, 2025 (JP) 2025-027147

(51) Int. Cl. G06F 3/12

(52) U.S. Cl. CPC G06F 3/1234; G06F 3/121; G06F 3/1264

(57) ABSTRACT

An image forming system includes a processor configured to: inspect a presence or absence of a fault on each page of a printed material; and when disposal pages including a page determined to have a fault are discharged into a second discharge destination different from a first discharge destination into which a page determined not to have a fault is to be discharged, discharge a sheet material used for blinding on top of disposal pages of a printed material having print contents set to be higher in confidentiality after the disposal pages are discharged into the second discharge destination.

### CROSS-REFERENCE TO RELATED APPLICATIONS

This application is based on and claims priority under 35 USC 119 from Japanese Patent Application No. 2025-027147 filed Feb. 21, 2025.

### BACKGROUND

### Technical Field

The present disclosure relates to an image forming system, a non-transitory computer readable medium and an image forming method.

### Related Art

Japanese Unexamined Patent Application Publication No. 2021-165020 discloses an inspection system that inspects the quality of a printed material. The inspection system includes an inspection unit, display controller, receiver, and controller. The inspection unit inspects the quality of the printed material by comparing a reference image with a scan image resulting from scanning the printed material. The display controller displays a screen that is used to receive a first mode that does not switch a discharge destination of the printed material regardless of the inspection results of the printed material and a second mode that switches the discharge destination of the printed material depending on the inspection results of the printed material. The receiver receives via the screen the first mode that does not switch a discharge destination of the printed material regardless of the inspection results of the printed material and the second mode that switches the discharge destination of the printed material depending on the inspection results of the printed material. The controller controls the discharge destination of the printed material in accordance with the mode received by the receiver and the inspection results obtained when the inspection unit has performed inspection.

Japanese Unexamined Patent Application Publication No. 2022-146528 discloses an inspection apparatus that performs inspection on a printed material by comparing a reference image with the printed material. The inspection apparatus includes a controller that performs exclusive control between an inspection mode and one of inspection job and an inspection type. The inspection mode is used to switch a discharge destination of a printed material determined to have a fault, the inspection job is used to inspect one or more printed materials and the inspection type is used to inspect a printed material that is arranged in a sequential order.

Japanese Unexamined Patent Application Publication No. 2024-6762 discloses an inspection apparatus. The inspection apparatus includes an acquisition unit and a setting unit. The acquisition unit acquires page information on a printed material serving as an inspection target that is printed through a printer. The acquisition unit acquires the page information including information related to print page and information related to a page of an insertion sheet that is to be inserted in the printed material. The setting unit displays on a display a setting screen that is used to perform a setting related to inspection on each page in accordance with the acquired page information and the setting unit further performs a setting for inspection on each page related to the printed page and the page of the insertion sheet in accordance with user operation on the setting screen.

Each page of a printed material is inspected for the presence or absence of a fault on the printed material produced by a printer, and a page determined to have a fault and a subsequent page in the middle of transportation are determined to be purge pages and discharged into a discharge destination, such as a top tray, different from a tray for normal pages. A printed material having print contents higher in confidentiality, such as a printed material including personal information, is typically discharged into a discharge destination, such as a stacker tray, from which the print contents are difficult to visually recognize. However, if a purge page on a printed material higher in confidentiality is discharged into a discharge destination, such as a top tray, which is easy to visually recognize from the outside, the print contents of the printed material may be possibly leaked.

### SUMMARY

Aspects of non-limiting embodiments of the present disclosure relate to providing an image forming system, a non-transitory computer readable medium and an image forming method that may block leaks of print contents of a disposal page on a printed material set to be higher in confidentiality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a processor configured to: inspect a presence or absence of a fault on each page of a printed material; and when disposal pages including a page determined to have a fault are discharged into a second discharge destination different from a first discharge destination into which a page determined not to have a fault is to be discharged, discharge a sheet material used for blinding on top of disposal pages of a printed material having print contents set to be higher in confidentiality after the disposal pages are discharged into the second discharge destination.

### BRIEF DESCRIPTION OF THE DRAWINGS

Exemplary embodiment of the present disclosure will be described in detail based on the following figures, wherein:

FIG. 1 illustrates the system configuration of an image forming system in an exemplary embodiment of the disclosure;

FIG. 2 illustrates reprinting that is performed by discharging, into a top tray, disposal pages that include a page having a print fault detected in inspection;

FIGS. 3A through 3D illustrate a process of the image forming system when the purge pages are discharged into the top tray;

FIG. 4 is a block diagram illustrating the hardware configuration of the image forming system in the exemplary embodiment of the disclosure;

FIG. 5 is a block diagram illustrating the functional configuration of the image forming system in the exemplary embodiment of the disclosure;

FIG. 6 illustrates a setting screen example of a setting that enables or disables a function that discharges a sheet material used for blinding onto a disposal page having print contents higher in confidentiality;

FIG. 7 illustrates an example of a determination method used when confidentiality is determined in accordance with print contents;

FIG. 8 is a flowchart illustrating a discharge operation of a sheet material used for blinding in the image forming system in an exemplary embodiment of the disclosure;

FIGS. 9A through 9D illustrate an example of a process of the image forming system when the sheet material used for blinding is discharged after the disposal pages including a page from which a print fault is detected in inspection are discharged into the top tray; and

FIGS. 10A through 10D illustrate another example of the process of the image forming system when the sheet material used for blinding is discharged after the disposal pages including the page from which the print fault is detected in inspection are discharged into the top tray.

### DETAILED DESCRIPTION

Exemplary embodiment of the disclosure is described in detail with reference to the drawings.

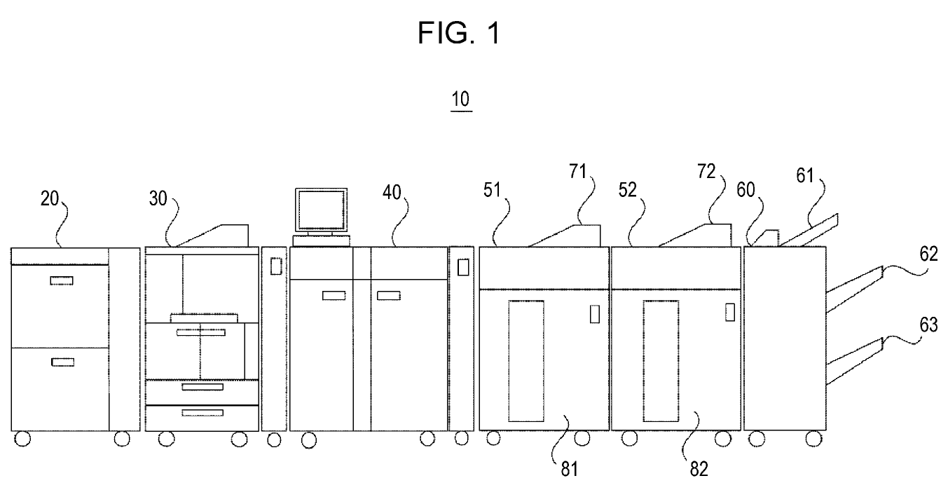

FIG. 1 illustrates the system configuration of an image forming system 10 in the embodiment of the disclosure.

Referring to FIG. 1, the image forming system 10 in the exemplary embodiment of the disclosure includes a paper feeder 20, printer 30, inspection apparatus 40, large-capacity stacker apparatuses 51 and 52 and post-processing apparatus 60.

The paper feeder 20 holding paper sheets supplies the printer 30 with the paper sheets. The printer 30 has the function of performing a printing operation to print an image on the paper sheet supplied by the paper feeder 20. The inspection apparatus 40 receives from the printer 30 the paper sheet with the image printed thereon and inspects the image printed on the paper sheet, namely, determines whether the image printed on the paper sheet has a fault, such as printing stains, bent corner or misregistration.

Specifically, the inspection apparatus 40 receives, as a reference image, image data of the image printed on the paper sheet from the printer 30, scans the image on the paper sheet transported from the printer 30, compares the received reference image with the scanned image, and thus inspects whether the image printed on the transported paper sheet has any fault.

The large-capacity stacker apparatus 51 includes a top tray 71 and stacker tray 81. The large-capacity stacker apparatus 52 includes a top tray 72 and stacker tray 82.

The stacker trays 81 and 82 are discharge destinations that are configured to protect a discharged paper sheet with a door and are capable of holding a large quantity of paper sheets having undergone the printing operation. The top trays 71 and 72 are respectively arranged on top of the large-capacity stacker apparatuses 51 and 52. The top trays 71 and 72 are discharge destinations into which the paper sheets having failed in the inspection of the inspection apparatus 40 are discharged.

The post-processing apparatus 60 performs, on the paper sheets inspected by the inspection apparatus 40, post-processing operations including a folding operation, stapling operation, punching operation and booklet production operation, and then discharges the paper sheets into a designated discharge tray. Note that the post-processing apparatus 60 includes the top tray 61 and finisher trays 62 and 63.

When a fault is detected on a paper sheet on the inspection apparatus 40, the image forming system 10 changes the discharge destination of the paper sheet detected to have the fault to a discharge tray different from a standard discharge tray and then discharges the paper sheet into the selected discharge tray. When a fault is detected on the paper sheet serving as an inspection target in such an operation, performing simply reprinting may cause the page to be misaligned and multiple consecutive pages of a printed material may not be printed in correct order.

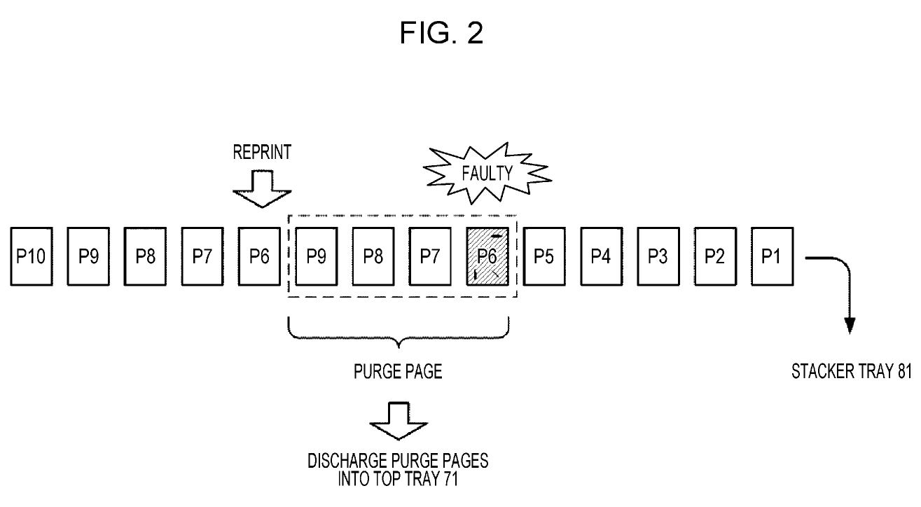

For example, referring to FIG. 2, page 6 may now be determined to have a print fault when 10 pages are printed on paper sheets having A4 sheet size. In the following discussion, a page determined to have a normal inspection result is discharged into the stacker tray 81 and a page detected to have a fault in an inspection result is discharged into the top tray 71. It is assumed in the following discussion that an image of one page is printed on a paper sheet.

Since in such a case, three paper sheets of pages 7 through 9 as the subsequent pages are already printed, simply reprinting only page 6 determined to have a faulty inspection result is not sufficient. When the inspection apparatus 40 determines that page 6 has a faulty inspection result, the three paper sheets of pages 7 through 9 are already printed and remain in the printer 30. In such a case, the discharge destination is switched to the top tray 71 as a discharge tray for disposal and four paper sheets of pages 6 through 9 are then discharged as purge pages (also referred to as disposal pages) into the top tray 71. Reprinting starting with page 6 causes a normal print result to be discharged into the stacker tray 81 in the order of from pages 1 through 10 without page misalignment.

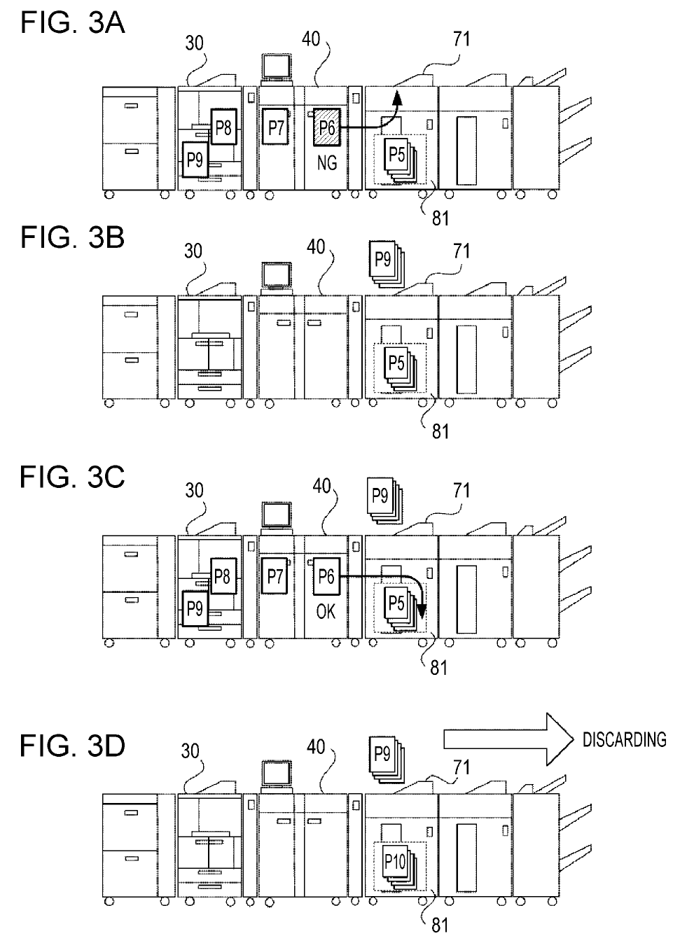

FIGS. 3A through 3D illustrate the process of the image forming system 10 that discharges the purge pages in this way into the top tray 71.

FIG. 3A illustrates the state in which the inspection apparatus 40 has detected a fault in a print result of page 6 with a print result of five pages 1 through 5 held in the stacker tray 81. When the fault is detected, subsequent four paper sheets of pages 7 through 9 have been printed. The discharge destination is thus changed such that the print result including pages 6 through 9 is discharged as purge pages into the top tray 71.

Through this operation, as illustrated in FIG. 3B, the five paper sheets of pages 1 through 5 as a normal print result are held in the stacker tray 81 while the four paper sheets of pages 6 through 9 including page 6 detected to have a fault in a print result are discharged into the top tray 71. The printer 30 then pauses the printing operation.

The printer 30 resumes printing starting with page 6 as illustrated in FIG. 3C. The inspection apparatus 40 may now determine in the inspection that page 6 is normal after reprinting. For this reason, page 6 and subsequent pages are discharged into the stacker tray 81.

Referring to FIG. 3D, as a result, when the printer 30 has completed the printing operation, the normal ten paper sheets of pages 1 through 10 are held in the stacker tray 81 while pages 6 through 9 including page 6 detected to have the fault in the print result are discharged into the top tray 71. The print result including four paper sheets of pages 6 through 9 discharged into the top tray 71 are to be discarded.

A printed material having print contents higher in confidentiality, such as a printed material including personal information, is typically discharged into the discharge destination that causes the print content to be difficult to visually recognize, such as the stacker tray 81. If a purge page in a printed material higher in confidentiality is discharged into the discharge destination that is visually recognizable from the outside, such as the top tray 71, the contents of the printed material may be possibly leaked.

Particularly when a large number of pages possibly taking a longer time before the completion of the printing operation are printed, disposal pages, such as purge pages, go unattended in the top tray 71 until the completion of the printing operation.

By performing the control operation described below, the image forming system 10 in the exemplary embodiment may block the leaks of the print contents of the purge pages (also referred to as disposal pages) of the printed material having the print contents higher in confidentiality.

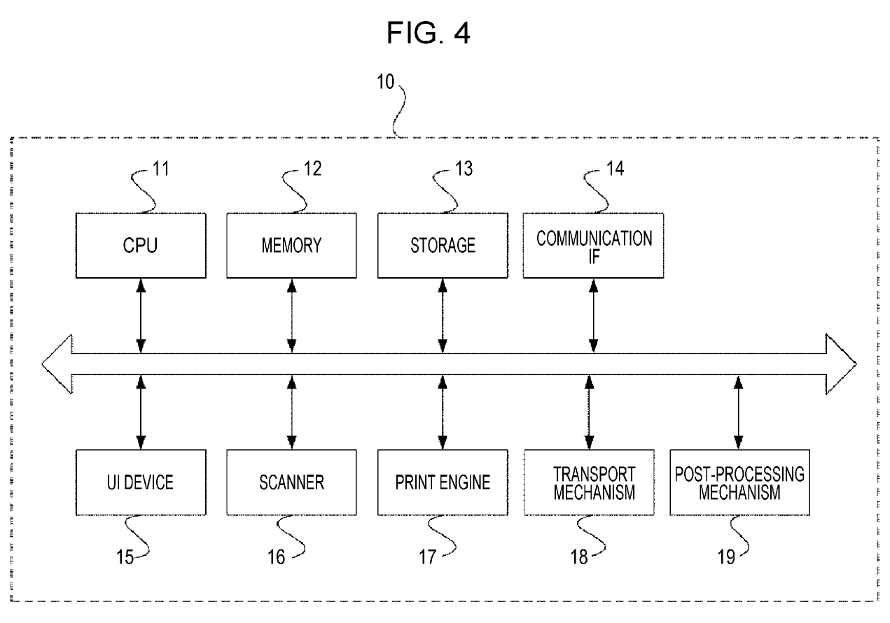

FIG. 4 illustrates the hardware configuration of the image forming system 10 in the exemplary embodiment. Referring to FIG. 4, for convenience of explanation, the image forming system 10 has a hardware configuration having one central processing unit (CPU) but the image forming system 10 may have a hardware configuration in which the printer 30, inspection apparatus 40, large-capacity stacker apparatuses 51 and 52 and post-processing apparatus 60 are respectively equipped with their own CPUs.

As illustrated in FIG. 4, the image forming system 10 includes a CPU 11, memory 12, storage 13 such as a hard disk drive, communication interface (IF) 14 transmitting data to or receiving data from an external apparatus via a network, user interface (UI) device 15 including a touch panel or a liquid-crystal display and keyboard, scanner 16, print engine 17, transport mechanism 18 and post-processing mechanism 19. Those elements are interconnected to each other via a control bus.

The print engine 17 prints an image on a recording medium, such as a paper sheet, through charging, exposure, development, transfer, fixing and other operations. The recording medium may include paper, film or the like or may be anything that allows an image to be printed thereon.

The CPU 11 performs a specific operation in accordance with a control program stored on the memory 12 or the storage 13 and is a processor controlling the process of the image forming system 10. According to the exemplar embodiment, the CPU 11 retrieves the control program from the memory 12 or the storage 13 and executes the retrieved control program but the disclosure is not limited to this method. The control program may be delivered in a recorded form on a computer-readable medium. For example, the control program may be delivered in a recorded form on an optical disc, such a compact disc read-only memory (CD-ROM) or digital versatile disc ROM (DVD-ROM), or semiconductor memory such as a universal serial bus (USB) memory or memory card. The control program may be retrieved from an external apparatus via a communication network connected to the communication IF 14. The control program may be supplied as standalone application software or may be supplied by building the control program into software of an element having a function of the image forming system 10.

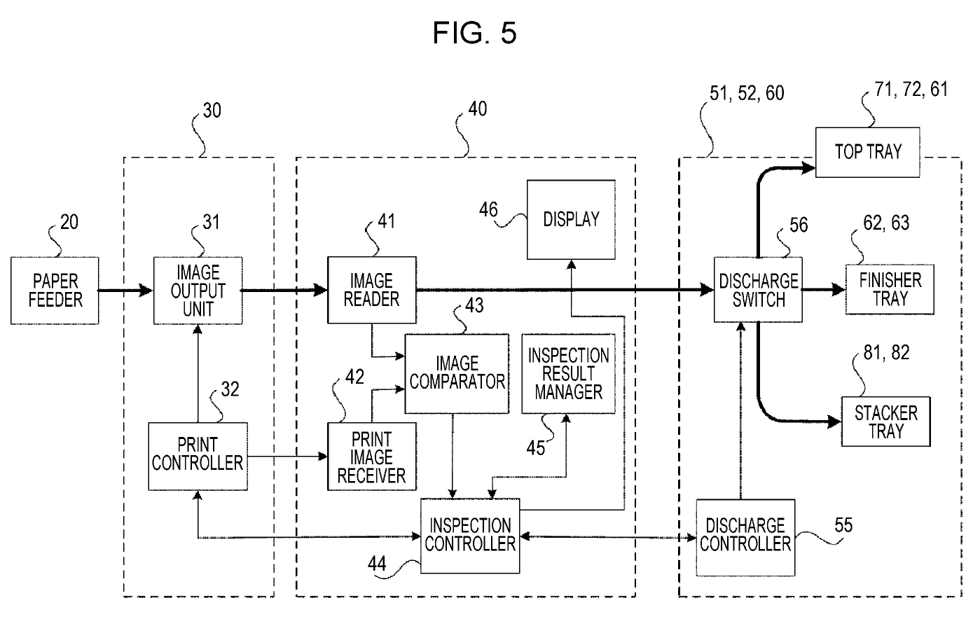

FIG. 5 is a block diagram illustrating the functional configuration of the image forming system 10 implemented when the control program is executed.

As illustrated in FIG. 5, in the image forming system 10 in the exemplary embodiment, the printer 30 includes an image output unit 31 and print controller 32. The inspection apparatus 40 includes an image reader 41, print image receiver 42, image comparator 43, inspection controller 44, inspection result manager 45 and display 46. Each of the large-capacity stacker apparatuses 51 and 52 and post-processing apparatus 60 includes top trays 71, 72 and 61, finisher trays 62 and 63, stacker trays 81 and 82, discharge switch 56 and discharge controller 55. Note that the post-processing mechanism 19 is not illustrated in the post-processing apparatus 60 in FIG. 5.

The paper feeder 20 holds the paper sheets before an image is formed thereon and then feeds the paper sheets to the image output unit 31. The image output unit 31 prints an image on the paper sheets fed by the paper feeder 20. The print controller 32 controls the process of the image output unit 31, causing the image output unit 31 to perform an operation to print the image on the paper sheet. Note that the print controller 32 transmits information on a print image printed on the paper sheet to the inspection controller 44 in the inspection apparatus 40.

The image reader 41 in the inspection apparatus 40 reads the image from the paper sheet having the image printed by the image output unit 31. The print image receiver 42 receives as a reference image the print image transmitted from the print controller 32.

The image comparator 43 compares a scan image read by the image reader 41 with the reference image as the print image received by the print image receiver 42 in order to determine whether the image printed on the paper sheet has any fault, such as a print fault. Specifically, by comparing the scan image with the reference image, the image comparator 43 detects printing stains, printing blur, toner fault or the like on the printed paper sheet. Note that the image comparator 43 may set one of the images read by the image reader 41 to be a reference image and compare the reference image with the other scan images.

The inspection controller 44 controlling the process of the inspection apparatus 40 receives inspection results from the image comparator 43 and inspects the printed image by determining whether a detected fault is in excess of a preset threshold of the inspection. The inspection result manager 45 stores and manages the inspection results of the inspection controller 44.

The inspection controller 44 transmits the inspection results to the print controller 32 and discharge controller 55. Specifically, the inspection controller 44 transmits to the print controller 32 information on the page that has been determined to have a print fault and information on the page that reprinting is to be started with. The inspection controller 44 also transmits to the discharge controller 55 information on the page that has been determined to have the print fault and information on the purge page serving as information on a page that is to be discarded before reprinting is performed. The inspection controller 44 also displays information on the inspection results and the like on the display 46.

The discharge switch 56 switches the discharge destination of the paper sheet transported from the inspection apparatus 40 to one of the top trays 71, 72 and 61, finisher trays 62 and 63 and stacker trays 81 and 82. In accordance with the information on the purge page and the like transmitted from the inspection controller 44, the discharge controller 55 performs control to provide the discharge switch 56 with an instruction about which discharge destination the discharge switch 56 is to switch to.

The print controller 32, inspection controller 44 and discharge controller 55 operate in concert with each other by transmitting or receiving information to or from each other, thereby controlling the overall process of the image forming system 10.

The image forming system 10 in the exemplary embodiment is configured as described above and is thus enabled to switch the discharge destination to a different tray such that the paper sheets that the inspection apparatus 40 has determined to be normal are discharged into one tray and the paper sheets of the purge pages including a paper sheet that the inspection apparatus 40 has determined to have a print fault are discharged into another tray. Discharging page herein signifies that a paper sheet having a page image printed thereon is discharged. The purge page refers to a paper sheet that is to be discharged into a discharge tray that is different from a tray into which a paper sheet determined to be normal is to be discharged. The functions of the print controller 32, inspection controller 44 and discharge controller 55 may be implemented by a terminal apparatus external to the image forming system 10 and the terminal apparatus may control the process of the image forming system 10 from the outside.

As described above, the inspection apparatus 40 inspects each page of a printed material for the presence or absence of a fault. According to the exemplar embodiment, by controlling the discharge controller 55, the inspection controller 44 discharges purge pages including a page determined to have a fault into a discharge destination different from a discharge destination into which a page determined to be free from any fault is discharged. In discharging the pages into the discharge destination different from the discharge destination into which the page determined to be free from any fault is discharged, the inspection controller 44 discharges a sheet material used for blinding on the purge pages of the printed material having the print contents set to be higher in confidentiality after discharging the purge pages.

For example, the inspection controller 44 controls the discharge controller 55 such that a page determined to be free from any fault of the printed material having the print contents not determined to be higher in confidentiality is discharged into the stacker tray 81 and the purge pages of the printed material are discharged into the top tray 71. The inspection controller 44 further discharges into the stacker tray 81 a page determined to be free from any fault of the printed material having the print contents set to be higher in confidentiality. After discharging the purge pages into the top tray 71, the inspection controller 44 controls the discharge controller 55 to feed a blank sheet PS serving as a sheet material used for blinding from the paper feeder 20 and discharge the blank sheet PS onto the purge pages.

The purge pages include the page that the inspection apparatus 40 has determined to be faulty and other pages that are subsequent to the faulty page and in middle of transportation on a paper sheet transport path.

After the purge pages are discharged into the stacker tray 82, the inspection controller 44 controls the print controller 32 such that reprinting starts with the page determined to be faulty.

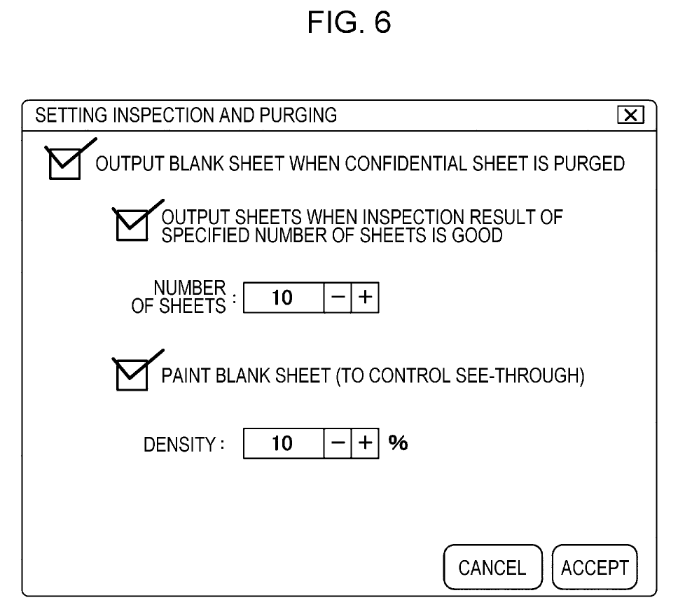

FIG. 6 illustrates a setting screen example of a setting that enables or disables the above-described function.

A check box with the message reading “Output blank sheet when confidential sheet is purged” is selected in the setting screen example illustrated in FIG. 6 and the setting enabling the above-described function is thus selected. When the user deselects the check box, the function is disabled and the purge pages of the printed material set to be higher in confidentiality are discharged into the top tray 71. The “sheet” herein refers to a paper sheet.

The setting screen example illustrated in FIG. 6 may allow the user to specify a discharge timing of the blank sheet. Specifically, the check box for “Output sheets when inspection result of specified number of sheets is good” is selectable on the setting screen example illustrated in FIG. 6. The number of sheets may be increased or decreased on the setting screen example illustrated in FIG. 6.

The check box for “Paint blank sheet (for anti-see-through)” is selectable on the setting screen example illustrated in FIG. 6. The density of painting may be increased or decreased on the setting screen example in FIG. 6.

The inspection controller 44 sets to be a printed material having print contents higher in confidentiality a printed material for which the user has entered a notification indicative of higher confidentiality or a printed material that is determined to be higher in confidentiality based on the print contents thereof. Specifically, the inspection controller 44 regards the printed material having a higher confidentiality as a control target for which the user has entered the notification indicative of a higher confidentiality via a screen operation. Alternatively, the inspection controller 44 may regard a printed material having personal information different from page to page as a printed material having a higher confidentiality, thus as a control target.

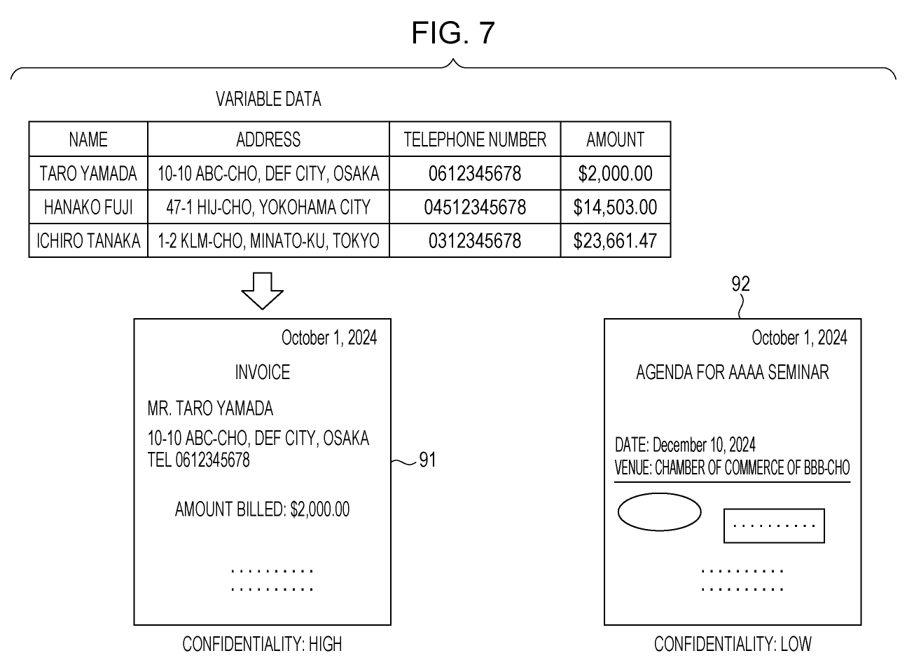

FIG. 7 illustrates an example of a determination method used when confidentiality is determined in accordance with print contents.

Printed material 91 includes print contents that are different from page to page and each page is generated using variable data including the personal information, such as name, address, telephone number and amount billed and the inspection controller 44 determines to be higher in confidentiality the printed material 91 that is different in content from page to page. Conversely, the inspection controller 44 determines to be lower in confidentiality a printed material 92 with the pages having the same contents. Note that the print controller 32 may perform the determination as to whether a printed material is higher or not and then transmit the determination results to the inspection controller 44.

The process of the image forming system 10 of the exemplary embodiment is described below with reference to the drawings.

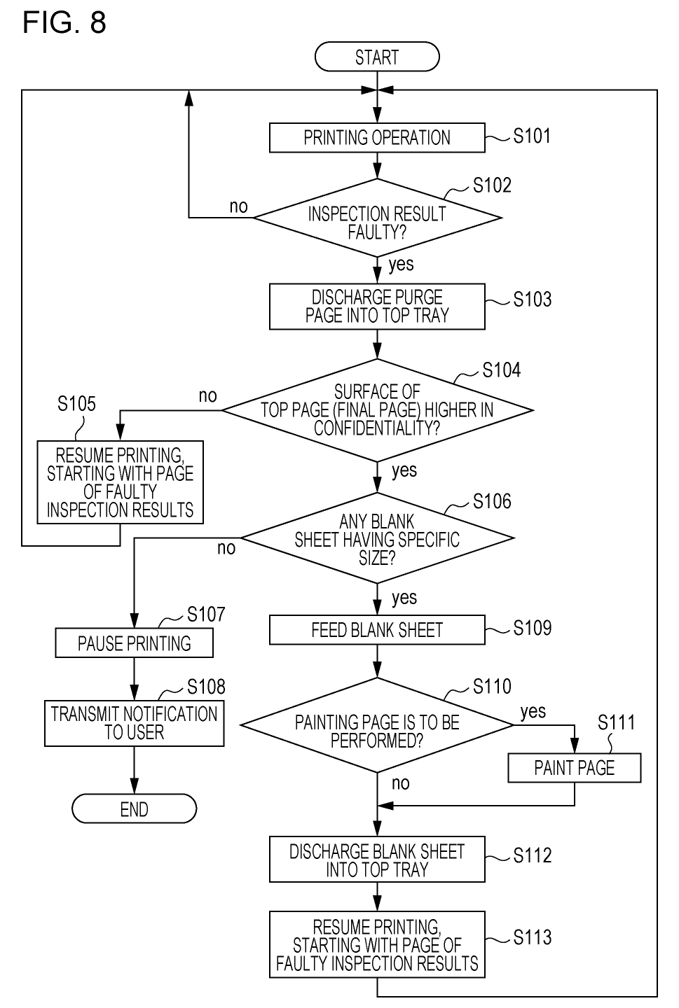

FIG. 8 is a flowchart illustrating a discharge operation of a sheet material used for blinding in the image forming system 10 of the exemplary embodiment.

The printer 30 performs a printing operation on each page in step S101. In step S102, the inspection apparatus 40 inspects whether each page has a fault in the print results.

If the print results are determined not to be faulty in step S102, the printer 30 continues to perform the printing operation. If the print results are determined to be faulty in step S102, the inspection controller 44 controls in step S103 the discharge controller 55 such that the purge pages are discharged into the top tray 71.

In step S104, the inspection controller 44 determines whether the printed material is determined to be a printed material that is set to be higher in confidentiality. Specifically, the inspection controller 44 determines whether the print contents included in the surface of the top page (also referred to as the final page) of the purge pages are higher in confidentiality. If the print contents included in the surface of the top page of the purge pages are determined to be not higher in confidentiality in step S104, the inspection controller 44 instructs the print controller 32 in step S105 to resume printing starting with a page that is determined to be faulty in inspection. The printer 30 then returns to step S101 to continue the printing operation.

If the surface of the top page of the purge pages is determined to be higher in confidentiality in step S104, the inspection controller 44 accesses the paper feeder 20 in step S106 to determine whether a blank sheet serving a sheet material used for blinding having a specific size is available. Specifically, the inspection controller 44 selects a blank sheet equal to or larger than the purge pages in size and accesses the paper feeder 20 to determine whether the selected blank sheet is available.

Upon determining in step S106 that no blank sheet is available, the inspection controller 44 pauses printing in step S107 by controlling the print controller 32 and transmits a notification to the user in step S108. The notification to the user may indicate discarding the purge pages discharged into the top tray 71, replenishing the blank sheet, and the like.

Upon determining in step S106 that a blank sheet is available, the inspection controller 44 feeds the blank sheet in step S109 by controlling the paper feeder 20.

In step S110, the inspection controller 44 determines in step S110 whether the blank is to be painted. If the blank sheet is to be painted, the inspection controller 44 paints the blank sheet in step S111 by controlling the print controller 32. When the blank sheet is painted, the density of painting may be set.

If the blank sheet is not to be painted or after the blank sheet is painted, the inspection controller 44 discharges the blank sheet into the top tray 71 in step S112 by controlling the discharge controller 55. In this way, the blank sheet is placed onto the purge pages and the print contents higher in confidentiality are thus hidden.

In step S113, the inspection controller 44 instructs the print controller 32 to resume printing starting with a page determined to be faulty in inspection. The printer 30 then returns to step S101 to continue the printing operation.

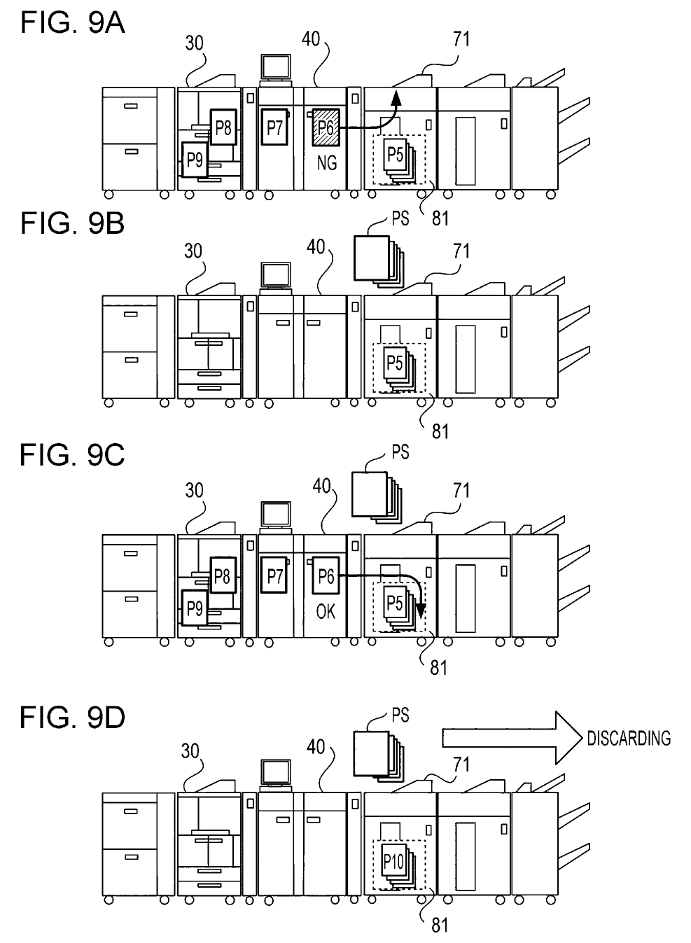

FIGS. 9A through 9D illustrate an example of a process of the image forming system 10 when the blank sheet PS is discharged onto the purge pages after the purge pages are discharged into the top tray 71.

FIG. 9A illustrates the state in which the inspection apparatus 40 has detected a fault in a print result on page 6 with pages 1 through 5 held in the stacker tray 81. When the fault is detected, subsequent pages 7 through 9 have been printed. The discharge destination is thus changed such that the print result including pages 6 through 9 is discharged as the purge pages into the top tray 71.

Through this operation, as illustrated in FIG. 9B, pages 1 through 5 as a normal print result are held in the stacker tray 81 while pages 6 through 9 including page 6 detected to have a fault in a print result are discharged into the top tray 71. The printer 30 then pauses the printing operation. If the printed material is higher in confidentiality, the inspection apparatus 40 causes the paper feeder 20 to feed the blank sheet PS and then discharges the blank sheet PS onto the purge pages (6 through 9 pages) discharged in the top tray 71. Specifically, if the print contents included in the surface of the top page of the purge pages are higher in confidentiality, the inspection apparatus 40 discharges the blank sheet PS onto the purge pages.

The printer 30 resumes printing starting with page 6 as illustrated in FIG. 9C. The inspection apparatus 40 may now determine in the inspection that page 6 is normal after reprinting. For this reason, page 6 and subsequent pages are discharged into the stacker tray 81.

Referring to FIG. 9D, as a result, when the printer 30 has completed the printing operation, the normal pages 1 through 10 are held in the stacker tray 81 while pages 6 through 9 including page 6 detected to have the fault in the print result are discharged into the top tray 71. The print result including pages 6 through 9 discharged into the top tray 71 are then to be discarded.

Since the image forming system 10 of the exemplary embodiment discharges the blank sheet PS onto the purge pages of the printed material set to be higher in confidentiality after the purge pages of the printed material are discharged in the top tray 71, the leakage of the print contents of the purge pages may be controlled.

The image forming system 10 may consume the blank sheets less than when the blank sheet is discharged on the surface of the top page if the print contents included in the surface of the top page of the discharged purge pages are lower in confidentiality.

The image forming system 10 may more reliably hide the purge pages with the sheet material than when a blank sheet smaller in size than the discharged purge pages is selected.

Since the blank sheet contained in the paper feeder 20 is used as a sheet material, the image forming system 10 may reduce more an increase in the cost of the sheet material than when a dedicated item (dedicated sheet) is used as the sheet material.

The image forming system 10 may control the leakage of the print contents through transparency by painting the blank sheet in comparison with the case in which the purge pages are hidden using an unpainted blank paper.

Since the user is notified, with printing pause, of the replenishment of the blank sheet and the discarding of the purge pages, the image forming system 10 may control the leakage of the print contents higher in confidentiality in comparison with the case in which the user is notified of only the replenishment of the sheet material.

The disposal pages includes a page determined to be faulty and other pages that are subsequent to the faulty page and in the middle of transportation on a paper sheet transport path in the image forming system 10. For this reason, the image forming system 10 may output the printed material of the normal pages without disrupting the page order.

The image forming system 10 sets to be a printed material having print contents higher in confidentiality a printed material for which the user has entered a notification indicative of higher confidentiality or a printed material that is determined to be higher in confidentiality based on the print contents thereof. The print contents of the printed material may be protected from being leaked automatically or in accordance with the user’s setting.

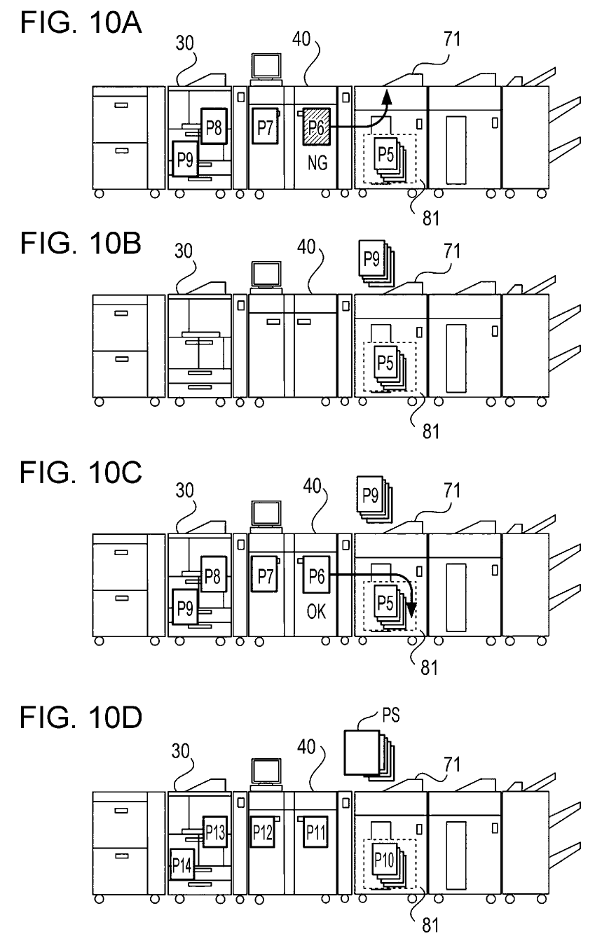

FIGS. 10A through 10D illustrate another example of the process of the image forming system 10 when the blank sheet PS is discharged onto the purge pages after the purge pages are discharged into the top tray 71.

Like FIG. 9A, FIG. 10A illustrates the state in which the inspection apparatus 40 has detected a fault in a print result on page 6 with pages 1 through 5 held in the stacker tray 81. When the fault is detected, subsequent pages 7 through 9 have been printed. The discharge destination is thus changed such that the print result including pages 6 through 9 is discharged as the purge pages into the top tray 71.

Through this operation, as illustrated in FIG. 10B, pages 1 through 5 as a normal print result are held in the stacker tray 81 while pages 6 through 9 including page 6 detected to have a fault in a print result are discharged into the top tray 71. The printer 30 then pauses the printing operation.

The printer 30 resumes printing starting with page 6 as illustrated in FIG. 10C. The inspection apparatus 40 may now determine in the inspection that page 6 is normal after reprinting. For this reason, page 6 and subsequent pages are discharged into the stacker tray 81.

Referring to FIG. 10D, as a result, when the printer 30 has completed the printing operation, the normal pages 1 through 10 are held in the stacker tray 81 while pages 6 through 9 including page 6 detected to have the fault in the print result are discharged into the top tray 71. When the printed material is higher in confidentiality, the inspection apparatus 40 feeds the blank sheet PS from the paper feeder 20 and then discharges the blank sheet PS on the purge pages (pages 6 through 9) discharged into the top tray 71. Specifically, if the print contents included in the surface of the top page of the purge pages are higher in confidentiality, the blank sheet PS is discharged on the purge pages. The blank sheet PS and the print result including pages 6 through 9 discharged into the top tray 71 are then discarded. During reprinting, the consumption of the blank sheets serving as the sheet material may be restricted more than when the blank sheet is discharged onto the top page of the purge pages even if the print contents included in the surface of the top page of the purge pages discharged into the top tray 71 are lower in confidentiality.

When printing is paused with user intervention and the sheet material is not yet discharged onto the purge pages, the sheet material may be discharged onto the purge pages. In this way even when printing is paused with user intervention, the print contents of the disposal pages may thus be protected from being leaked. When the print contents of the surface of the top page of the purge pages are higher in confidentiality, the blank sheet may be discharged onto the purge pages.

The blank sheet may be discharged onto each page having the print contents higher in confidentiality.

In the exemplary embodiment above, the term "processor" refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term "processor" is broad enough to encompass one processor or plural processors in collaboration which are located physically apart from each other but may work cooperatively. The order of operations of the processor is not limited to one described in the exemplary embodiment above, and may be changed.

The “system” in the exemplary embodiment may be configured to include a single apparatus or multiple apparatuses.

The disclosure may be applicable to a program and/or a program product.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including:

a processor configured to:

inspect a presence or absence of a fault on each page of a printed material; and

when disposal pages including a page determined to have a fault are discharged into a second discharge destination different from a first discharge destination into which a page determined not to have a fault is to be discharged, discharge a sheet material used for blinding on top of disposal pages of a printed material having print contents set to be higher in confidentiality after the disposal pages are discharged into the second discharge destination.

(((2)))

In the image forming system according to (((1))), the processor is configured to discharge the sheet material onto a surface of a top page of the disposal pages discharged into the second discharge destination when the print contents included in the surface of the top page of the disposal pages are higher in confidentiality.

(((3)))

In the image forming system according to (((1))), the processor is configured to:

after the disposal pages are discharged into the second discharge destination, resume reprinting starting with a page that is determined to have a fault;

inspect a presence or absence of a fault on each reprinted page; and

when the reprinted pages are determined to be free from any fault, discharge the sheet material onto the disposal pages.

(((4)))

In the image forming system according to (((3))), the processor is configured to discharge the sheet material onto the disposal pages when the print contents included in the surface of the top page of the disposal pages discharged into the second discharge destination are higher in confidentiality and the reprinted pages are determined to be free from any fault.

(((5)))

In the image forming system according to one of (((1))) through (((4))), the processor is configured to select as the sheet material a sheet material having a size larger than or equal to the disposal pages discharged into the second discharge destination.

(((6)))

In the image forming system according to (((5))), the sheet material is a blank sheet.

(((7)))

In the image forming system according to (((5))), the sheet material is a blank sheet material that is painted.

(((8)))

In the image forming system according to one of (((5))) through (((7))), the processor is configured to, when the sheet material having the selected size is not available from a feeder, pause printing and make a notification that prompts a user to discard the disposal pages discharged into the second discharge destination and replenish the sheet material.

(((9)))

In the image forming system according to one of (((1))) through (((8))), the processor is configured to discharge the sheet material onto the disposal pages when printing is paused with user intervention and the sheet material is not yet discharged onto the disposal pages.

(((10)))

In the image forming system according to one of (((1))) through (((9))), the disposal pages include the page determined to have the fault and a second page that is in middle of transportation on a paper sheet transport path and subsequent to the page determined to have the fault.

(((11)))

In the image forming system according to one of (((1))) through (((10))), the processor is configured to set to be the printed material having the print contents higher in confidentiality a printed material that has an indication, input by a user and indicating a higher confidentiality, or a printed material that is determined to be higher in confidentiality in accordance with the print contents.

(((12)))

A program causing a computer to execute a process including:

inspecting a presence or absence of a fault on each page of a printed material; and

when disposal pages including a page determined to have a fault are discharged into a second discharge destination different from a first discharge destination into which a page determined not to have a fault is to be discharged, discharging a sheet material used for blinding on top of disposal pages of a printed material having print contents set to be higher in confidentiality after the disposal pages are discharged into the second discharge destination.

What is claimed is:

1. An image forming system comprising:
a processor configured to:
inspect a presence or absence of a fault on each page of a printed material; and
when disposal pages including a page determined to have a fault are discharged into a second discharge destination different from a first discharge destination into which a page determined not to have a fault is to be discharged, discharge a sheet material used for blinding on top of disposal pages of a printed material having print contents set to be higher in confidentiality after the disposal pages are discharged into the second discharge destination.

2. The image forming system according to claim 1, wherein the processor is configured to discharge the sheet material onto a surface of a top page of the disposal pages discharged into the second discharge destination when the print contents included in the surface of the top page of the disposal pages are higher in confidentiality.

3. The image forming system according to claim 1, wherein the processor is configured to:
after the disposal pages are discharged into the second discharge destination, resume reprinting starting with a page that is determined to have a fault;
inspect a presence or absence of a fault on each reprinted page; and
when the reprinted pages are determined to be free from any fault, discharge the sheet material onto the disposal pages.

4. The image forming system according to claim 3, wherein the processor is configured to discharge the sheet material onto the disposal pages when the print contents included in the surface of the top page of the disposal pages discharged into the second discharge destination are higher in confidentiality and the reprinted pages are determined to be free from any fault.

5. The image forming system according to claim 1, wherein the processor is configured to select as the sheet material a sheet material having a size larger than or equal to the disposal pages discharged into the second discharge destination.

6. The image forming system according to claim 2, wherein the processor is configured to select as the sheet material a sheet material having a size larger than or equal to the disposal pages discharged into the second discharge destination.

7. The image forming system according to claim 3, wherein the processor is configured to select as the sheet material a sheet material having a size larger than or equal to the disposal pages discharged into the second discharge destination.

8. The image forming system according to claim 4, wherein the processor is configured to select as the sheet material a sheet material having a size larger than or equal to the disposal pages discharged into the second discharge destination.

9. The image forming system according to claim 5, wherein the sheet material is a blank sheet.

10. The image forming system according to claim 6, wherein the sheet material is a blank sheet.

11. The image forming system according to claim 7, wherein the sheet material is a blank sheet.

12. The image forming system according to claim 8, wherein the sheet material is a blank sheet.

13. The image forming system according to claim 5, wherein the sheet material is a blank sheet material that is painted.

14. The image forming system according to claim 6, wherein the sheet material is a blank sheet material that is painted.

15. The image forming system according to claim 5, wherein the processor is configured to, when the sheet material having the selected size is not available from a feeder, pause printing and make a notification that prompts a user to discard the disposal pages discharged into the second discharge destination and replenish the sheet material.

16. The image forming system according to claim 1, wherein the processor is configured to discharge the sheet material onto the disposal pages when printing is paused with user intervention and the sheet material is not yet discharged onto the disposal pages.

17. The image forming system according to claim 1, wherein the disposal pages comprise the page determined to have the fault and a second page that is in middle of transportation on a paper sheet transport path and subsequent to the page determined to have the fault.

18. The image forming system according to claim 1, wherein the processor is configured to set to be the printed material having the print contents higher in confidentiality a printed material that has an indication, input by a user and indicating a higher confidentiality, or a printed material that is determined to be higher in confidentiality in accordance with the print contents.

19. A non-transitory computer readable medium storing a program causing a computer to execute a process comprising:
inspecting a presence or absence of a fault on each page of a printed material; and
when disposal pages including a page determined to have a fault are discharged into a second discharge destination different from a first discharge destination into which a page determined not to have a fault is to be discharged, discharging a sheet material used for blinding on top of disposal pages of a printed material having print contents set to be higher in confidentiality after the disposal pages are discharged into the second discharge destination.

20. An image forming method comprising:
inspecting a presence or absence of a fault on each page of a printed material; and
when disposal pages including a page determined to have a fault are discharged into a second discharge destination different from a first discharge destination into which a page determined not to have a fault is to be discharged, discharging a sheet material used for blinding on top of disposal pages of a printed material having print contents set to be higher in confidentiality after the disposal pages are discharged into the second discharge destination.
